(19) United States
(12) Patent Application Publication
(10) Pub. No.: US 2026/0304519 A1
(43) Pub. Date: Oct. 1, 2026

(54) CONTROLLING COMMUNICATION BETWEEN PEER WIRELESS DEVICES VIA CONTROL PATH OF A DIFFERENT NETWORK

(71) Applicant: Silicon Laboratories Inc., Austin, TX (US)

(72) Inventors: Hasan Ali Stationwala, Hyderabad (IN); Ayan Bandhu Ghosh, Hyderabad (IN); Manish Kothari, Hyderabad (IN); Payal Singh, Hyderabad (IN); Atul Joshi, Hyderabad (IN)

(21) Appl. No.: 19/092,289

(22) Filed: Mar. 27, 2025

(51) Int. Cl. H04W 76/15; H04W 76/12; H04W 76/30

(52) U.S. Cl. CPC H04W 76/15; H04W 76/12; H04W 76/30

(57) ABSTRACT

In one embodiment, a method includes: onboarding, via a second device, a first wireless device into a wireless network, including establishing a first control path between the first wireless device and the second device via the wireless network and establishing a first physical link between the first wireless device and the second device, where the first physical link is of the wireless network; associating the first wireless device with at least one device included in the wireless network, including: establishing a second control path between the first wireless device and the at least one device via the wireless network; and establishing a second physical link between the first wireless device and the at least one device, where the second physical link is separate from the wireless network; and disconnecting the second physical link and maintaining the second control path while the second physical link is disconnected.

### BACKGROUND OF THE INVENTION

Some wireless devices communicate with each other using point-to-point communication, such as via a Bluetooth-based communication. Additionally, these or other wireless devices may also communicate in a wireless mesh network, which is a decentralized network in which devices can communicate with each other via relay with one or more other devices within the mesh network. In contrast, Internet Protocol (IP)-based devices use centralized networking with routers and switches to route data over larger networks.

Bluetooth connections may be suitable for low latency point-to-point communications; however, there are various concerns. For example, devices may incur some amount of power consumption even in an idle mode, as certain messaging still occurs between the devices. In addition, from a user perspective there is complexity involved in initial onboarding of this device with one or more other devices, and user involvement is required when switching between the device and one or more other devices.

### SUMMARY OF THE INVENTION

In one aspect, a method includes: onboarding, via a second device, a first wireless device into a wireless network, comprising establishing a first control path between the first wireless device and the second device via the wireless network and establishing a first physical link between the first wireless device and the second device or a third device, wherein the first physical link is of the wireless network; associating the first wireless device with at least one device included in the wireless network, comprising: establishing a second control path between the first wireless device and the at least one device via the wireless network; and establishing a second physical link between the first wireless device and the at least one device, wherein the second physical link is separate from the wireless network; and disconnecting the second physical link and maintaining the second control path while the second physical link is disconnected.

In one implementation, the method further includes associating the first wireless device with the at least one device comprising the third device without user involvement. The method may also include configuring the second device as a central controller to onboard the first wireless device into the wireless network.

In an implementation, the method further comprises: receiving, in the central controller, a request from the at least one device for connection of the second physical link; and communicating with the first wireless device via the first control path to initiate the connection of the second physical link between the first wireless device and the at least one device to enable data communication via the second physical link, where the first control path is a connectionless logical link. The method may also include: while the first wireless device is in an idle mode, receiving, in the central controller, a request from the at least one device for discovery of a network resource; and communicating with the first wireless device via the first control path to cause the first wireless device to enter into a discoverable mode, wherein when the first wireless device is in the discoverable mode the at least one device is to discover the first wireless device via the second physical link.

In an implementation, the method further includes: receiving, in the central controller, a request from the at least one device for connection of the first wireless device; and communicating with the first wireless device via the first control path to cause the first wireless device to enter into a connection mode, wherein when the first wireless device is in the connection mode the at least one device is to connect with the first wireless device via the second physical link. The method may also include: communicating first attribute information of the first wireless device to the at least one device via the second control path, the first attribute information comprising general attribute information; and communicating second attribute information of the first wireless device to the at least one device via the second physical link, the second attribute information comprising scenario-specific attribute information.

In an implementation, the method further includes sequentially associating the first wireless device with a plurality of devices included in the wireless network, comprising: establishing a corresponding control path between the first wireless device and a corresponding one of the plurality of devices via the wireless network; establishing a corresponding physical link between the first wireless device and a corresponding one of the plurality of devices; and disconnecting the corresponding physical link and maintaining the corresponding control path while the corresponding physical link is disconnected.

In one implementation, the method further includes: determining at least one parameter of operation of the first wireless device; negotiating, between the first wireless device and the third device, for selection of one of the first physical link or the second physical link for a data communication, based at least in part on the at least one parameter of operation; and performing the data communication between the first wireless device and the third device via the selected one of the first physical link or the second physical link.

In another aspect, an apparatus includes: a wireless transceiver to transmit and receive radio frequency (RF) signals of at least a first wireless protocol and a second wireless protocol, wherein the wireless transceiver is to use the first wireless protocol for communication within an Internet Protocol (IP)-based network and use the second wireless protocol for communication within a wireless network separate from the IP-based network; and a controller coupled to the wireless transceiver.

In one implementation, the controller is configured to: onboard a first wireless device into the IP-based network via a first control path of the IP-based network between the first wireless device and the apparatus and a first physical link between the apparatus and the first wireless device, wherein the first physical link is of the IP-based network; associate the first wireless device with another device included in the IP-based network via a second control path of the IP-based network between the first wireless device and the another device and a second physical link between the first wireless device and the another device, wherein the second physical link is separate from the IP-based network; and disconnect the second physical link and maintain the second control path while the second physical link is disconnected.

In an implementation, the controller is further configured to: negotiate with the first wireless device, for selection of one of the first physical link or a third physical link between the apparatus and the first wireless device, the third physical link separate from the IP-based network, for a data communication, based at least in part on at least one parameter of operation of at least one of the apparatus or the first wireless device; and perform the data communication with the first wireless device via the selected one of the first physical link or the third physical link.

In an implementation, the controller is further configured, in response to a request from the another device for connection of the second physical link, to communicate with the first wireless device via the first control path to initiate the connection of the second physical link between the first wireless device and the another device to enable data communication via the second physical link, wherein the first control path comprises a connectionless logical link.

In an implementation, the controller is further configured to receive a request from the another device for discovery of at least one device while the first wireless device is in an idle mode, and communicate with the first wireless device via the first control path to cause the first wireless device to enter into a discoverable mode, wherein when the first wireless device is in the discoverable mode the another device is to discover the first wireless device via the second physical link.

In an implementation, the controller, in response to a notification of activity associated with the first wireless device, is to cause a physical link to be connected between the first wireless device and at least one other device in the IP-based network, wherein the controller is to receive the notification of activity via the first control path according to the second wireless protocol, and wherein data communication via the physical link is according to the first wireless protocol.

In an implementation, the apparatus further comprises a bridge circuit to communicate second wireless protocol messages with the first wireless device and to communicate IP-based messages with the another device, the first wireless device to communicate only via the wireless network. The bridge circuit may be configured to cause a key exchange of a first key to occur between the first wireless device and the another device, where the first key is to be used for end-to-end encryption of data communication between the first wireless device and the another device.

In yet another aspect, a method includes: maintaining a first control path via a wireless network between a first wireless device and the device while the first wireless device is in a low power state; receiving, via the first control path, a request from the first wireless device for establishment of a physical link via the wireless network, in response to activity associated with the first wireless device; and causing the physical link to be established between the first wireless device and the device or a second device included in the wireless network. The physical link may be of a point-to-point wireless connection separate from the wireless network, to enable data communication via the physical link between the first wireless device and the device or the second device.

In an implementation, the method further comprises: onboarding the first wireless device into the wireless network, comprising establishing the first control path between the first wireless device and the device via the wireless network and establishing a first physical link between the first wireless device and the device, wherein the first physical link is separate from the wireless network; associating the first wireless device with the second device, comprising: establishing a second control path between the first wireless device and the second device via the wireless network; and establishing a second physical link between the first wireless device and the second device, where the second physical link is separate from the wireless network; and disconnecting the second physical link and maintaining the second control path while the second physical link is disconnected.

In an implementation, the method further comprises: communicating first attribute information between the device and the first wireless device via the first control path; and communicating second attribute information between the device and the first wireless device via the physical link, wherein a size of the second attribute information is greater than a size of the first attribute information.

In an implementation, the method further comprises: communicating, via a bridge circuit of the device, generic attribute profile (GATT) messages with the first wireless device; and communicating IP-based messages with the second device, the first wireless device to communicate only via the wireless network, the IP-based messages comprising additional attribute messages.

In one example, a computer-readable storage medium including instructions is to perform the methods described above. In another example, a computer-readable storage medium including data is to be used by at least one machine to fabricate at least one integrated circuit to perform the methods described above. In yet another example, an apparatus comprises means for performing the methods described above.

### BRIEF DESCRIPTION OF THE DRAWINGS

FIG. 1 is a high-level block diagram of a wireless network in accordance with an embodiment.

FIG. 2A is a block diagram illustrating operation of a network in accordance with an embodiment.

FIG. 2B is a block diagram illustrating operation of a network in accordance with another embodiment.

FIG. 3 is a flow diagram of a method in accordance with an embodiment.

FIG. 4A is a flow diagram of a method in accordance with another embodiment.

FIG. 4B is a flow diagram of a method in accordance with yet another embodiment.

FIG. 5 is a block diagram of a wireless network in accordance with another embodiment.

FIG. 6 is a block diagram of a representative integrated circuit in accordance with an embodiment.

FIG. 7 is a high level diagram of a network in accordance with an embodiment.

### DETAILED DESCRIPTION

In various embodiments, a wireless device may be configured to maintain a connection-less logical link with a plurality of peer devices, while maintaining a single physical link with one device. For purposes of discussion herein, this particular device is referred to as a controller. Although embodiments are not limited in this regard, this controller may act as a router, switch, and/or repeater. This controller may be configured to assist the onboarding of the wireless device with one or more possible peer devices, using a control path implemented via a network-based wireless protocol in a wireless network, which may be implemented as an IP-based network. Although embodiments are not limited in this regard, this wireless network may be implemented as a Thread or Zigbee low power IP-based wireless network. In yet other implementations, the wireless network may be implemented using a Matter protocol that runs over another protocol, such as a Wi-Fi or Thread protocol. Note that this control path and network are separate from a point-to-point connection such as a Bluetooth physical link via which the wireless device may communicate with one or more other peer devices in this network.

In this way, once a user establishes a connection between the central controller and the wireless device, other onboarding operations may be performed automatically without user involvement, intermediated via the central controller, to allow initial onboarding of this wireless device and other peer devices. After such initial onboarding is performed, the central controller also may be configured to establish direct Bluetooth or other point-to-point links on demand between the wireless device and a given peer device to accommodate a particular use case, such as data transfer between the peer device and the wireless device. In this way, a just-in-time or on-demand physical link can be established, avoiding power consumption and complexity involved in maintaining this physical link when devices are not actively communicating with each other.

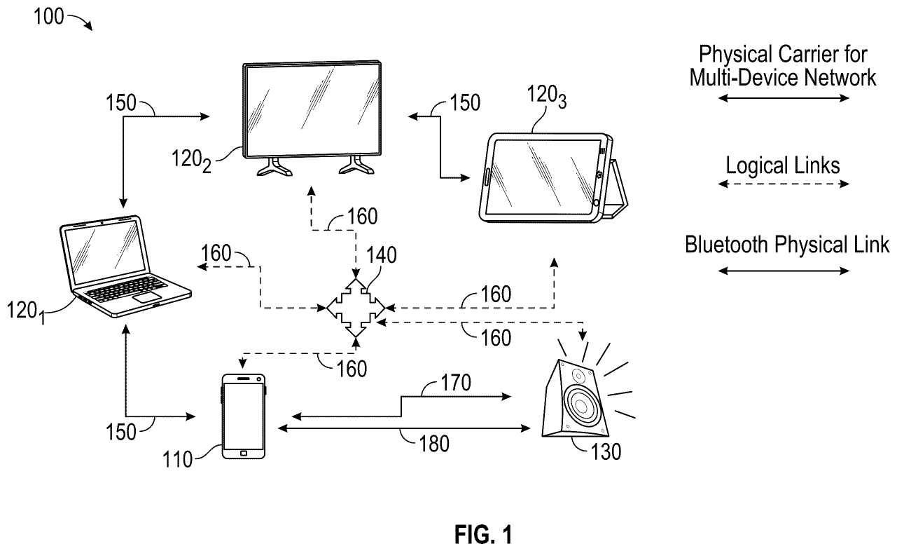

Referring now to FIG. 1, shown is a high-level block diagram of a wireless network in accordance with an embodiment. As shown in FIG. 1, a wireless network 100 includes a plurality of devices 110 and 120₁₋₃. Wireless network 100 may be implemented as an IP-based wireless network, as described above. In the high-level view shown in FIG. 1, the specific devices within network 100 include a smartphone 110, a notebook computer 120₁, a tablet computer 120₃, and a TV 120₂. In addition, another wireless device 130 is shown as a speaker, namely an audio sink device, which may be a Bluetooth device that can output audio data it receives from a given one of the peer devices within network 100.

In the illustration implementation of FIG. 1, assume that wireless device 130 is a Bluetooth-only device (meaning that its only communication mechanism is via Bluetooth) and thus is not included within wireless network 100, namely the IP-based wireless network. That said, as will be described herein, wireless device 130 nevertheless can still establish wireless links with devices within network 100. In other implementations, device 130 may, in addition to Bluetooth-based (and/or other point-to-point) communications, also provide for other network/mesh-based communications such that it may be natively included within wireless network 100.

To enable data communications between wireless device 130 and devices within wireless network 100, FIG. 1 further illustrates that certain of the devices within network 100 couple together via a physical connection 150 (which may be a wired or wireless connection). In addition, as shown with dashed connections, logical links 160 may be established between given ones of the various devices, via a router 140 which may be a logical router, implemented in one embodiment within smartphone 110. In one or more embodiments, smartphone 110 also may be configured to act as a central controller for the operations described herein.

Assume for purposes of discussion that in an initial state, network 100 includes smartphone 110 and devices 120 that may communicate within network 100 according to IP-based or other network/mesh communications via links 150. As examples, one or more of smartphone 110 and devices 120 may communicate via, e.g., Ethernet-based communications, Wi-Fi-based communications, among others in this initial state in which devices couple via logical links 160 and physical links 150.

Assume further that at a later time, wireless device 130 is introduced. As a first step to onboarding device 130, a physical link 170 and corresponding logical link 160 are established between device 130 and smartphone 110. This arrangement assumes an implementation in which smartphone 110 acts as a central controller that performs onboarding operations. In other cases, smartphone 110 may establish the communication channel with wireless device 130 and act as a bridge with another device 120 that implements a central controller for performing onboarding. In still other cases, smartphone 110 may act as a central controller for such onboarding, while another device 120 initiates a physical link with wireless device 130.

To enable operation as described herein, wireless device 130 first may be paired with smartphone 110 to establish Bluetooth physical link 170. In some cases, this initial onboarding may involve a user confirming this connection, e.g., via a manual pairing. Thereafter, once this initial pairing occurs, smartphone 110 may automatically establish pairings (e.g., Bluetooth pairings) of wireless device 130 with other peer devices 120. Note that these pairings may be performed automatically without any user involvement, and may result in creation of a Bluetooth physical link (not shown in FIG. 1) between wireless device 130 and each of peer devices 120.

However, in contrast to a conventional Bluetooth implementation, these Bluetooth links may remain in a disconnected state until an actual Bluetooth communication is to occur between the devices. In this way, power savings may be realized, as the need for keep alive or other status messaging in this disconnected state or idle mode can be avoided.

After this initial onboarding and creation of Bluetooth links between wireless device 130 and peer devices 120, wireless device 130 may remain in an idle mode in which it maintains a physical link with only a single device (namely smartphone 110 in this example), and logical links may exist between this device and other devices 120 via router 140.

When an application calls for use of a wireless device, e.g., as an audio sink device, an on-demand data path may be established between a source device of these peer devices and the wireless device. This on-demand data path may be established automatically using control paths of the network.

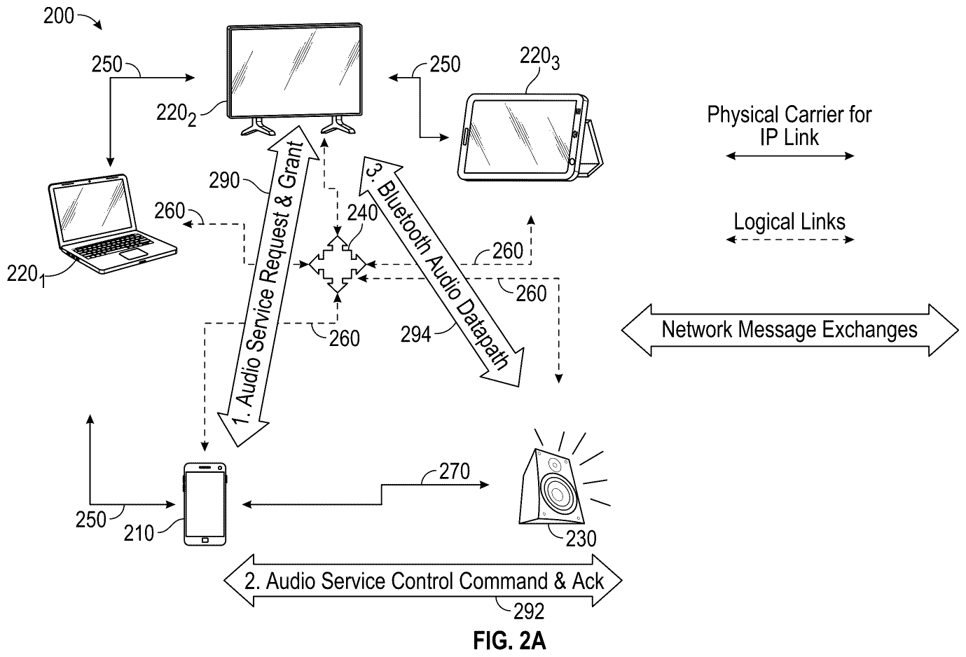

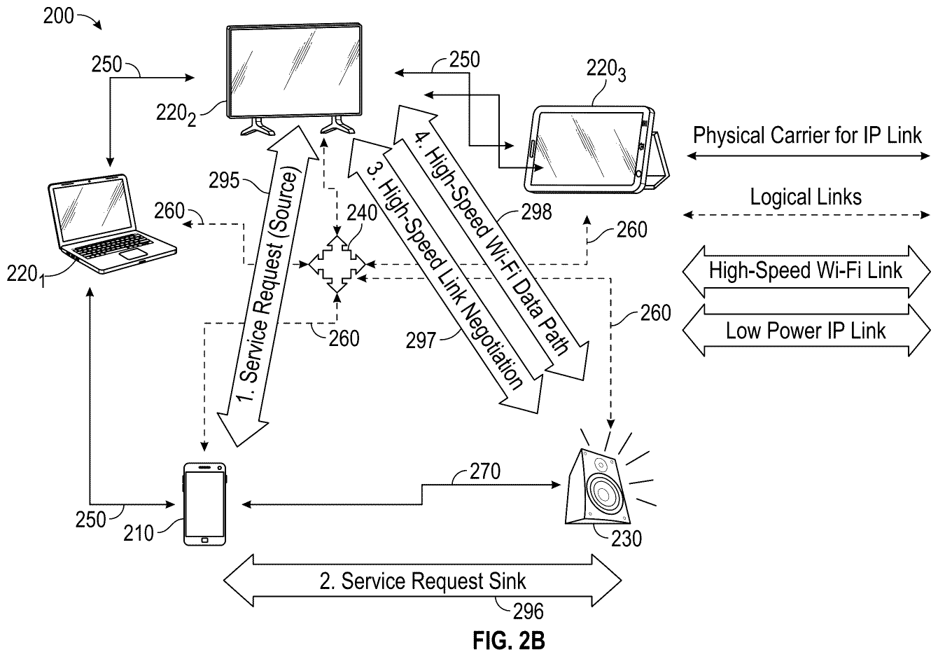

Referring now to FIG. 2A, shown is a block diagram illustrating operation of a network in accordance with an embodiment. In the embodiment of FIG. 2A, network 200 may be implemented the same as network 100, with the same devices and physical and logical links. As such, individual devices and connections within network 200 are not discussed further as these devices may be configured the same as devices 100 of FIG. 1 (albeit enumerated with the “200” series numbers in the FIG. 2A embodiment).

As shown in FIG. 2A, in this example TV 220₂ seeks to use speaker 230 as an audio sink device. To effect such operation, TV 220₂, via control path 260 of network 200, sends an audio service request 290 to smartphone 210. In turn, smartphone 210 issues a grant to TV 220₂, and also sends, via control path 260, message exchanges 292 with speaker 230, e.g., an audio service control command to speaker 230, which acknowledges it.

Thereafter, a Bluetooth data path 294 is activated between TV 220₂ and speaker 230, allowing it to communicate audio data to speaker 230 for output. Note that this activation of the previously established Bluetooth link and ensuing data communication occurs without user involvement, and proceeds via the Bluetooth link after the above-described signaling is performed via the separate network-based control path. While shown with this particular implementation in FIG. 2A, many variations and alternatives are possible.

Referring now to FIG. 2B, shown is a block diagram illustrating operation of a network in accordance with an embodiment. In the embodiment of FIG. 2B, network 200 may be implemented as in FIG. 2A, however in this implementation the control paths are of a low power IP wireless network such as an IEEE 802.15.4 network, and the side channel data communications may be via a high-speed Wi-Fi point-to-point link.

As shown in FIG. 2B, in this example TV 220₂ seeks to use speaker 230 as an audio sink device. To effect such operation, TV 220₂, via control path 260 of network 200, sends an audio service request 295 to smartphone 210 in which it is to act as a source. In turn, smartphone 210 issues a request 296 for speaker 230 to act as a sink device. In response to this request, a high-speed link negotiation 297 occurs directly between these devices and results in a high-speed Wi-Fi data path via which speaker 230 receives and outputs audio data from TV 220₂.

An arrangement such as described in FIG. 2B may be used when one device wants to use a service offered by another device. For example, a controller may want lossless audio to be streamed over to the speaker or the controller wants contents on a screen of a device with a small screen to be streamed for display on a large screen.

To effect such operation, the controller communicates with the devices over a wireless network (e.g., IEEE 802.15.4 links) to establish a high-speed point-to-point link (e.g., Wi-Fi link) between the devices. In one implementation, the devices then negotiate link parameters, which may include: channel number; bandwidth; role (e.g., station (STA)/soft access point (AP), Direct Link devices, P2PCIi/P2PGO); and timeout. The devices may assume the role of P2PGO/softAP/Direct Link devices before the time out, and a given device (e.g., source device) is responsible for making a secure connection and starting streaming over the high-speed link.

In some implementations, there may be multiple source and sink devices present in a given network. For example, there can be multiple audio sources and audio sinks in the network. Depending on implementation, such devices may support multiple wireless data paths, e.g., Wi-Fi and Bluetooth-based audio data paths. In such arrangement, an audio source and sink devices can negotiate particulars of the audio data path. In some cases, this negotiation may be based on one or more of a variety of parameters of one or more of the devices. Given that Wi-Fi-based audio may provide higher quality (than Bluetooth audio), and Bluetooth-based audio may provide higher power efficiency (than Wi-Fi audio), devices may make a decision based at least in part on battery levels, as one example parameter. As other examples, such adaptive audio selection of a particular protocol for data communication may be based, at least in part, on congestion or other such parameters.

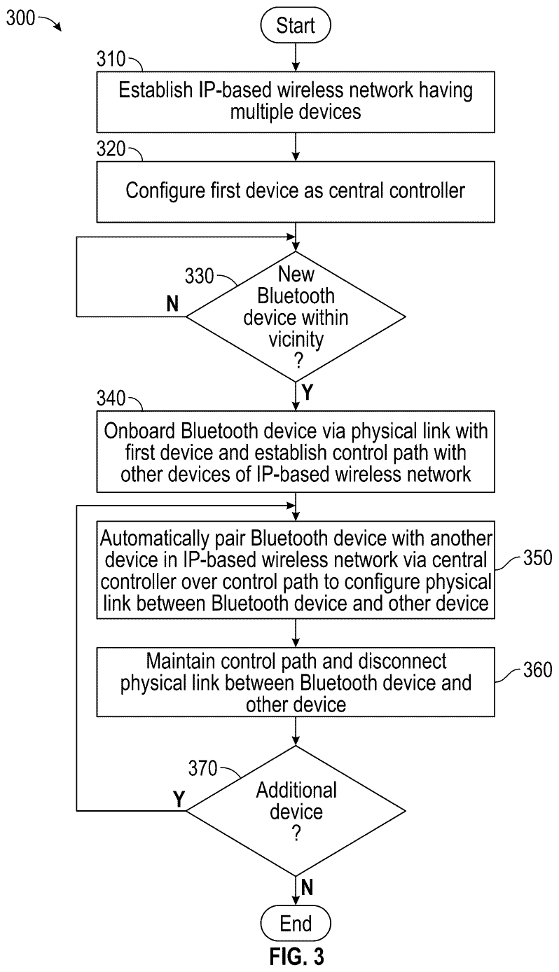

Referring now to FIG. 3, shown is a flow diagram of a method in accordance with an embodiment. As shown in FIG. 3, method 300 is a method for onboarding a wireless device into an IP-based or other wireless network and establishing a side channel control path that is separate from one or more physical links via which primary data communications occur. For purposes of discussion, method 300 is in the context of an IP-based wireless network, such as a given Thread, Zigbee, Matter, and/or Wi-Fi protocol in which a Bluetooth device can be onboarded. However, understand that embodiments are not limited in this regard and other types of networks/meshes may be used, and further understand that other peer-to-peer wireless devices such as IEEE 802.15.4 devices may be present instead of the example Bluetooth device.

Method 300 begins by establishing an IP-based wireless network having multiple devices (block 310). For example, with reference back to FIG. 1, this IP-based network may be network 100, and the multiple devices may include at least some of the devices shown in FIG. 1, such as smartphone and TV. Note that this IP-based network may be established according to known techniques, and may occur independently of any type of later onboarding of a Bluetooth or other wireless device.

Still referring to FIG. 3, at block 320 a first device of the networked devices may be configured as a central controller. For purposes of discussion, assume that this first device is a smartphone. Next at diamond 330 it is determined whether a new Bluetooth device is within a vicinity, e.g., within a wireless range of the first device or the IP-based wireless network more generally. If so, control passes to block 340. At block 340, the central controller may be configured to onboard the Bluetooth device via a physical link. In the context of a Bluetooth device, understand that this physical link may be a wireless Bluetooth physical link, e.g., an over-the-air channel between the devices. Also, at this block 340 a control path is established both with the first device and all other devices of the IP-based wireless network. To this end in one embodiment, the control path may be implemented as logical links that couple the Bluetooth device with the various other devices, via a logical router which in at least one example implemented via the smartphone acting as the central controller.

Still referring to FIG. 3, next at block 350 the Bluetooth device may be automatically paired or otherwise associated with another one of these devices within the network. To this end, the central controller may effect this automatic pairing, which is done over the control path to configure a physical link between the Bluetooth device and the other device. As part of this automatic pairing, understand that certain information, such as key information and other attribute information to enable Bluetooth communications to occur via this physical link, may be exchanged across the physical link and stored in respective storages, e.g., memories within the Bluetooth device and the other device.

Once this association or pairing has been completed, control passes to block 360 where the control path between these devices may be maintained. However, the physical link between them is disconnected. In this way, the power consumption and resources needed for sending keep alive messages across the physical link when at least the Bluetooth device is in an idle mode can be avoided.

Next it is determined at diamond 370 whether there is an additional device within the IP-based network that is to be paired with the Bluetooth device. If so, control passes back to block 350. Otherwise, method 300 concludes.

Thus, at this point, the Bluetooth device has been paired with all other appropriate devices within the IP-based network, yet only a single physical link, namely that between the Bluetooth device and the central controller, remains active. All other physical links with respect to the Bluetooth device and these other devices are in a disconnected state. However, understand that the control path remains active between the Bluetooth device and such paired devices within the IP-based network, which in an embodiment may be implemented via logical links between the Bluetooth device and these other devices, as intermediated via the logical router. As such, the Bluetooth device may be placed into an inactive mode without the need for sending keep alive messages with any of the other devices. When it or a given device seeks to communicate with the Bluetooth device, a just-in-time physical link can be established via a discovery and connection process involving the central controller as will be described further below.

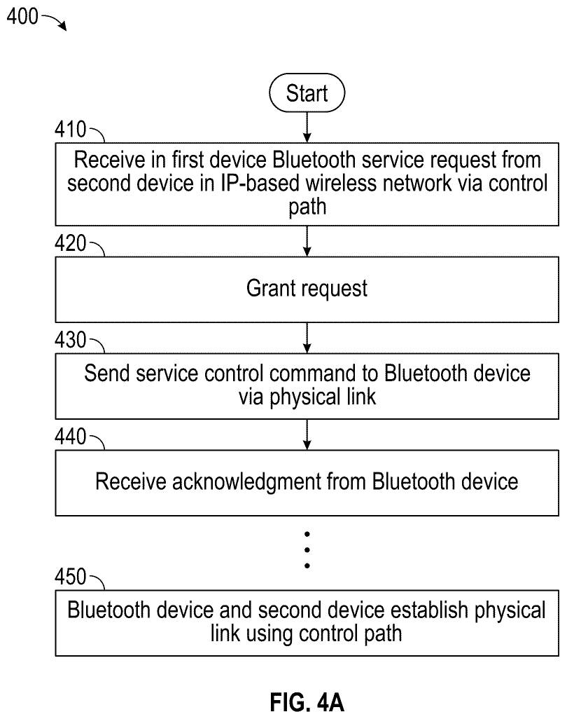

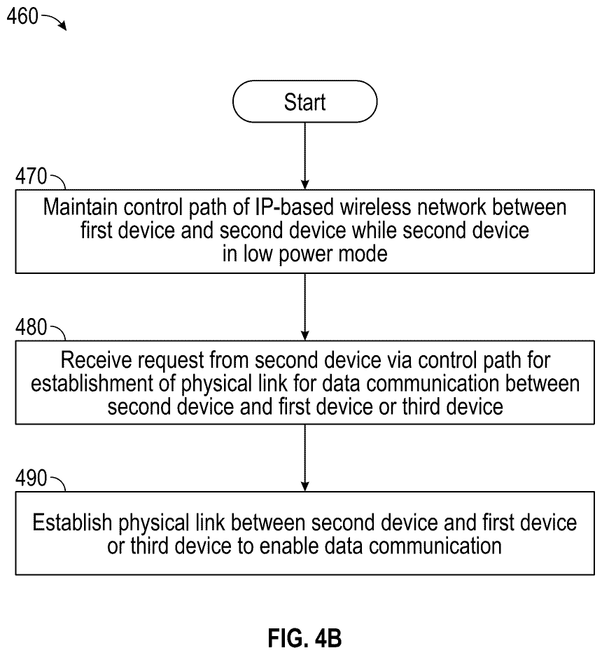

Referring now to FIG. 4A, shown is a flow diagram of a method in accordance with another embodiment. As shown in FIG. 4A, method 400 is a method for initiating communications via a wireless link using a separate side channel for control communications. Again for purposes of discussion, method 400 is in the context of an IP-based wireless network that provides a control path between various devices and a Bluetooth device that is to communicate with devices within the network via a physical link, namely a Bluetooth wireless physical link. Of course, embodiments can be used with other networks/meshes and different point-to-point connections.

Method 400 begins by receiving a Bluetooth service request in a first device (block 410). This first device may include a central controller, and with continuing reference to FIG. 1, the central controller may be implemented in this first device (e.g., smartphone). The Bluetooth service request in an example may be received from another device within the network, and may be received via a control path, such as a connectionless logical link. Assume for purposes of discussion that this second device is a TV within the network. Next at block 420 the central controller grants the request, sending a grant response back to the requester.

Still referring to FIG. 4A, in response to this request, the central controller also sends a service control command to the Bluetooth device (block 430). This service control command may be sent via the control path between the central controller and the Bluetooth device. At block 440 an acknowledgement is received from the Bluetooth device, which indicates that the Bluetooth device is available for handling this Bluetooth service request. For purposes of discussion, assume that this request is for the Bluetooth device to act as an audio sink device in which the TV acts as an audio source device, and thus seeks to communicate audio information to the Bluetooth device for output via the speaker of the Bluetooth device.

At this point, understand that the various control signaling to initiate a physical link between the Bluetooth device and the TV is complete and this physical link, namely a Bluetooth wireless physical link, is established. Thus as shown at block 450 these devices may establish this physical link using the control path. For example, various communications to enable establishment of this connection between the devices may proceed via the control path. However, understand that in other cases at least some these communications themselves may occur via the physical link. In any case, at this point the devices are appropriately configured and thus the source device can start sending audio and other data to the Bluetooth device via the physical link. Although shown at this high level in the embodiment of FIG. 4A, many variations and alternatives are possible.

In various embodiments, once a wireless device has been onboarded into a given wireless network, it may enter into a low power mode while maintaining the control path. For example, any of a variety of battery-powered wireless devices such as Internet of Things (IoT) sensors, doorbells or so forth may be onboarded into a wireless network and then enter into a low power mode while it is inactive. In this way the need for sending keep alive messages, e.g., via a Wi-Fi or other communication protocol, can be avoided.

When such wireless device detects activity, e.g., a doorbell press, motion sensing in a vicinity of a camera or so forth, it may request, via the control path, establishment of a physical link. Once this physical link is established, data communication, such as image, video or other data can be communicated using the physical channel. In a particular embodiment, the wireless device may be a smart doorbell, e.g., an IoT device that provides for communication via a Wi-Fi communication protocol and a low power wireless protocol such as a Thread communication protocol. In this implementation, the Thread protocol may remain active using the control path. Then on detection of activity, the doorbell may request via this control path the central controller to establish a physical channel, e.g., between the doorbell and the central controller (e.g., smartphone) and/or another device, such as a television, to enable data communication to occur, e.g., via a Wi-Fi protocol

Referring now to FIG. 4B, shown is a flow diagram of a method in accordance with yet another embodiment. As shown in FIG. 4B, method 460 is a method for establishing a just-in-time physical link between devices for performing a data communication. Again for purposes of discussion, method 460 is in the context of a wireless network such as an IP-based wireless network that provides a control path of a first wireless protocol between various devices and a wireless device that is to communicate with another device within the network via a physical link of different wireless protocol (e.g., a point-to-point protocol).

As shown in FIG. 4B, method 460 begins at block 470 by maintaining a control path of an IP-based wireless network between first and second devices, while the second device is in low power mode. Assume for purposes of discussion that the first device is a smartphone that acts as a central controller for the IP-based wireless network, and that the second device is a smart doorbell that can communicate according to multiple protocols, e.g., a Wi-Fi protocol and a Thread protocol (and potentially also a Bluetooth protocol). Next at block 480, the central controller receives from the second device via the control path a request for establishment of a physical link. This request may be received in response to detection of activity in the doorbell, e.g., a user press of the doorbell and/or detection of activity via a camera of the doorbell. Note that this request is for establishment of the physical link to enable data communication to occur between the doorbell and the smartphone and/or another device, such as a connected TV within the IP-based network.

Still referring to FIG. 4B, at block 490 this physical link may be established responsive to the request. Note that connection parameters for this physical link may have been previously established when the second wireless device was onboarded into the IP-based wireless network. In this way, an on-demand or just-in-time physical link is established between the doorbell (which acts as a source device) and the smartphone and/or connected TV (which acts as a destination device) for data communication of, e.g., video, image and/or audio information from the doorbell. Although shown at this high level in the embodiment of FIG. 4B, many variations and alternatives are possible.

Understand that prior to data communications via a physical link, attribute information first may be communicated. In some cases, at least some of this attribute information can be sent via the control path, while additional attribute information can be sent via the physical link. For example, general access attribute information can be sent via the control path, while use case-specific attribute information, which may be of a larger size than the general access attribute information, such as remote control attribute information, call handling attribute information or so forth, may be sent using the physical link. After such attribute communications, the source device may start sending data of a given information type to the sink device.

While different IP-based wireless networks can be used, in one example, a Matter framework can be used. To this end, a Matter framework can define a custom device type “Bluetooth” with a plurality of clusters to define typical operations performed by Bluetooth devices. One such cluster may be a basic cluster for general access, with at least one attribute for discover and discoverability and another attribute for connection and connect-ability, where this attribute information may be sent via a control path. The discover-focused attribute may be used to identify whether two devices are in connectable range, and can map to Inquiry and Inquiry scan procedures in Bluetooth Classic and Advertisement and Advertisement scans in Bluetooth Low Energy (BLE). The connection-focused attribute can be used to establish a Bluetooth physical layer connection between two devices, and may map to Page and Page scan procedures in Bluetooth Classic and connect and scans in BLE.

Depending on the particular device, there can also be use case-specific clusters, which may be sent via a physical channel, once established. For example, for an audio sink device such as a speaker, there can be remote control clusters having attributes for control aspects such as volume control, track control, playback state control, playback speed control, among others. More generally, clusters can be provided for aspects of the Bluetooth Audio/Video Remote Control Profile Specification. For a device with calling capabilities, a calling cluster can include call control attributes such as dial, pick up, disconnect, among others. More generally, clusters can be provided for aspects of the Bluetooth Hands Free Profile specification. Of course, other profiles and corresponding actions may be present in other embodiments. As examples, such additional cluster information can be provided for human interface device (HID) attributes, file browsing attributes or so forth.

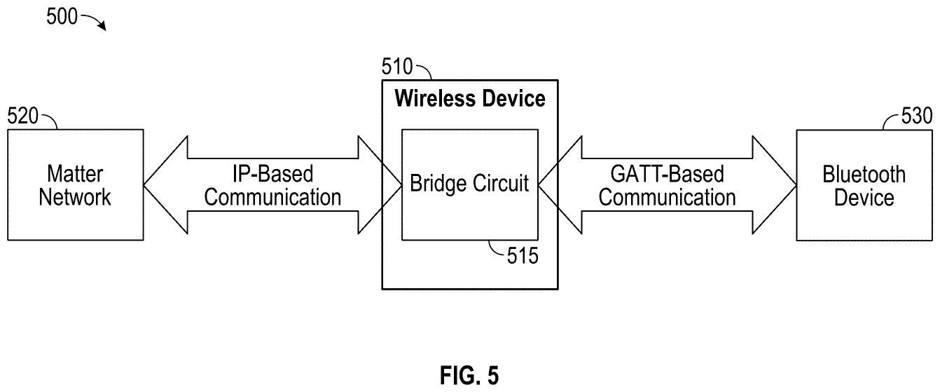

Referring now to FIG. 5, shown is a block diagram of a network in accordance with another embodiment. As shown in FIG. 5, network 500 is another wireless network with which embodiments may be used. In the high level view shown in FIG. 5, a wireless device 510 includes a bridge circuit 515 that is configured to implement generic attribute profile (GATT)-based communications with a Bluetooth device 530. In turn, wireless device 510 also may implement IP-based communications with one or more devices present in a Matter network 520. Matter network 520 is one example of an IP-based wireless network; as an example it may include at least some of the devices as shown in FIGS. 1 and 2A, 2B.

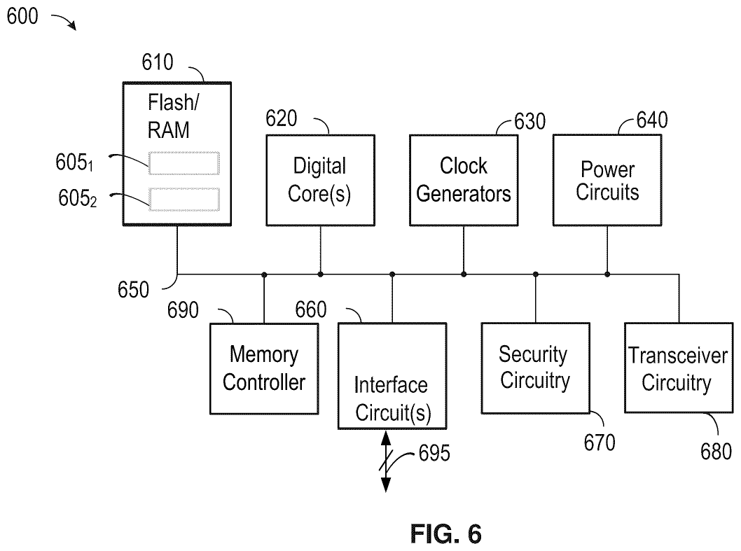

Referring now to FIG. 6, shown is a block diagram of a representative integrated circuit 600 that includes bridge and controller circuitry as described herein. In the embodiment shown in FIG. 6, integrated circuit 600 may be, e.g., a multi-mode wireless transceiver that may operate according to multiple wireless protocols including higher power and lower power wireless protocols, and which can be used in a variety of use cases. In one or more embodiments, the circuitry of integrated circuit 600 shown in FIG. 6 may be implemented on a single semiconductor die or implemented on separate dies for wireless communication, MCU compute, external flash and/or other IP blocks needed to perform various functionalities.

Integrated circuit 600 may be included in a range of devices, but for purposes of discussion, it may be incorporated into a smartphone. In the embodiment shown, integrated circuit 600 includes a memory system 610 which in an embodiment may include volatile storage, such as RAM and non-volatile memory such as a flash memory. The flash memory is a non-transitory storage medium that can store instructions and data. These instructions include a set of instructions that, when executed, cause control circuitry to onboard a wireless device into a wireless network and maintain control paths with the wireless device and other devices in the network, and dynamically enable an on-demand physical channel to be established between the wireless device and another network device, as described herein.

As further shown in FIG. 6, memory 610 may store first code 6051 for performing an onboarding routine to onboard a wireless device into, e.g., an IP-based network and maintaining a control path with that wireless device while one or more physical channels are disabled. As further shown, memory 610 may also store second code 6052 for dynamically causing a physical channel of a second wireless protocol to be established between a wireless device and another device in an IP-based wireless network, based at least in part on control path communications of a first wireless protocol, as described herein. Integrated circuit 600 also may include a memory controller 690.

Memory system 610 couples via a bus 650 to one or more digital cores 620, which may include one or more cores and/or microcontrollers that act as processing units of the integrated circuit, and which may execute code 6051,2. In turn, digital cores 620 may couple to clock generators 630 which may provide one or more phase locked loops or other clock generator circuitry to generate various clocks for use by circuitry of the IC.

As further illustrated, IC 600 further includes power circuitry 640. Additional circuitry may be present depending on particular implementation to provide various functionality and interaction with external devices. Such circuitry may include interface circuitry 660 which provides a digital communication interface with additional circuitry (such as another IC that can couple to IC 600 via a link 695). IC 600 also may include security circuitry 670 to perform wireless security techniques.

In addition, as shown in FIG. 6, transceiver circuitry 680 may be provided to enable transmission and reception of wireless signals, e.g., according to multiple wireless communication protocols, such as Matter, Thread, Zigbee, Bluetooth, IEEE 802.11, IEEE 802.15.4, cellular communication or so forth. Understand while shown with this high level view, many variations and alternatives are possible.

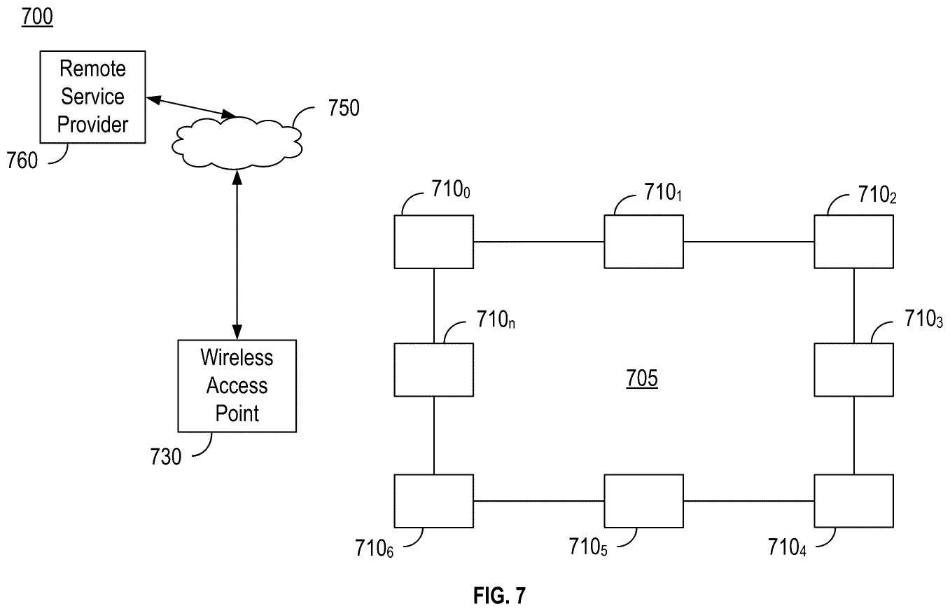

ICs such as described herein may be implemented in a variety of different devices as described above. Referring now to FIG. 7, shown is a high level diagram of a network in accordance with an embodiment. As shown in FIG. 7, a network 700 includes a variety of devices, including IoT and other wireless devices that may communicate in an IP-based wireless network using a control path and on-demand physical channels as described herein.

In the embodiment of FIG. 7, a wireless mesh network 705 is present, e.g., in an environment having multiple wireless devices 710₀₋ₙ. As shown, one or more wireless devices 710 may onboard a given wireless device, establish physical channels, and maintain such side channels, while disconnecting corresponding physical channels, as described herein. In some cases, one or more devices 710 may couple to an access point 730 that in turn communicates with a remote service provider 760 via a wide area network 750, e.g., the Internet. Understand while shown at this high level in the embodiment of FIG. 7, many variations and alternatives are possible.

While the present disclosure has been described with respect to a limited number of implementations, those skilled in the art, having the benefit of this disclosure, will appreciate numerous modifications and variations therefrom. It is intended that the appended claims cover all such modifications and variations.

1. A method comprising:
onboarding, via a second device, a first wireless device into a wireless network, comprising establishing a first control path between the first wireless device and the second device via the wireless network and establishing a first physical link between the first wireless device and the second device or a third device, wherein the first physical link is of the wireless network;
associating the first wireless device with at least one device included in the wireless network, comprising:
establishing a second control path between the first wireless device and the at least one device via the wireless network; and
establishing a second physical link between the first wireless device and the at least one device, wherein the second physical link is separate from the wireless network; and
disconnecting the second physical link and maintaining the second control path while the second physical link is disconnected.

2. The method of claim 1, further comprising associating the first wireless device with the at least one device comprising the third device without user involvement.

3. The method of claim 1, further comprising configuring the second device as a central controller to onboard the first wireless device into the wireless network.

4. The method of claim 3, further comprising:
receiving, in the central controller, a request from the at least one device for connection of the second physical link; and
communicating with the first wireless device via the first control path to initiate the connection of the second physical link between the first wireless device and the at least one device to enable data communication via the second physical link, wherein the first control path comprises a connectionless logical link.

5. The method of claim 3, further comprising:
while the first wireless device is in an idle mode, receiving, in the central controller, a request from the at least one device for discovery of a network resource; and
communicating with the first wireless device via the first control path to cause the first wireless device to enter into a discoverable mode, wherein when the first wireless device is in the discoverable mode the at least one device is to discover the first wireless device via the second physical link.

6. The method of claim 5, further comprising:
receiving, in the central controller, a request from the at least one device for connection of the first wireless device; and
communicating with the first wireless device via the first control path to cause the first wireless device to enter into a connection mode, wherein when the first wireless device is in the connection mode the at least one device is to connect with the first wireless device via the second physical link.

7. The method of claim 6, further comprising:
communicating first attribute information of the first wireless device to the at least one device via the second control path, the first attribute information comprising general attribute information; and
communicating second attribute information of the first wireless device to the at least one device via the second physical link, the second attribute information comprising scenario-specific attribute information.

8. The method of claim 1, further comprising sequentially associating the first wireless device with a plurality of devices included in the wireless network, comprising:
establishing a corresponding control path between the first wireless device and a corresponding one of the plurality of devices via the wireless network;
establishing a corresponding physical link between the first wireless device and a corresponding one of the plurality of devices; and
disconnecting the corresponding physical link and maintaining the corresponding control path while the corresponding physical link is disconnected.

9. The method of claim 1, further comprising:
determining at least one parameter of operation of the first wireless device;
negotiating, between the first wireless device and the third device, for selection of one of the first physical link or the second physical link for a data communication, based at least in part on the at least one parameter of operation; and
performing the data communication between the first wireless device and the third device via the selected one of the first physical link or the second physical link.

10. An apparatus comprising:
a wireless transceiver to transmit and receive radio frequency (RF) signals of at least a first wireless protocol and a second wireless protocol, wherein the wireless transceiver is to use the first wireless protocol for communication within an Internet Protocol (IP)-based network and use the second wireless protocol for communication within a wireless network separate from the IP-based network; and
a controller coupled to the wireless transceiver, wherein the controller is configured to:
onboard a first wireless device into the IP-based network via a first control path of the IP-based network between the first wireless device and the apparatus and a first physical link between the apparatus and the first wireless device, wherein the first physical link is of the IP-based network;
associate the first wireless device with another device included in the IP-based network via a second control path of the IP-based network between the first wireless device and the another device and a second physical link between the first wireless device and the another device, wherein the second physical link is separate from the IP-based network; and
disconnect the second physical link and maintain the second control path while the second physical link is disconnected.

11. The apparatus of claim 10, wherein the controller is further configured to:
negotiate with the first wireless device, for selection of one of the first physical link or a third physical link between the apparatus and the first wireless device, the third physical link separate from the IP-based network, for a data communication, based at least in part on at least one parameter of operation of at least one of the apparatus or the first wireless device; and
perform the data communication with the first wireless device via the selected one of the first physical link or the third physical link.

12. The apparatus of claim 10, wherein the controller is further configured, in response to a request from the another device for connection of the second physical link, to communicate with the first wireless device via the first control path to initiate the connection of the second physical link between the first wireless device and the another device to enable data communication via the second physical link, wherein the first control path comprises a connectionless logical link.

13. The apparatus of claim 10, wherein the controller is further configured to receive a request from the another device for discovery of at least one device while the first wireless device is in an idle mode, and communicate with the first wireless device via the first control path to cause the first wireless device to enter into a discoverable mode, wherein when the first wireless device is in the discoverable mode the another device is to discover the first wireless device via the second physical link.

14. The apparatus of claim 10, wherein the controller, in response to a notification of activity associated with the first wireless device, is to cause a physical link to be connected between the first wireless device and at least one other device in the IP-based network, wherein the controller is to receive the notification of activity via the first control path according to the second wireless protocol, and wherein data communication via the physical link is according to the first wireless protocol.

15. The apparatus of claim 10, further comprising a bridge circuit to communicate second wireless protocol messages with the first wireless device and to communicate IP-based messages with the another device, the first wireless device to communicate only via the wireless network.

16. The apparatus of claim 15, wherein the bridge circuit is to cause a key exchange of a first key to occur between the first wireless device and the another device, wherein the first key is to be used for end-to-end encryption of data communication between the first wireless device and the another device.

17. A computer-readable storage medium comprising instructions that when executed by at least one processor of a device cause the device to perform a method comprising:
maintaining a first control path via a wireless network between a first wireless device and the device while the first wireless device is in a low power state;
receiving, via the first control path, a request from the first wireless device for establishment of a physical link via the wireless network, in response to activity associated with the first wireless device; and
causing the physical link to be established between the first wireless device and the device or a second device included in the wireless network, wherein the physical link is of a point-to-point wireless connection separate from the wireless network, to enable data communication via the physical link between the first wireless device and the device or the second device.

18. The computer-readable storage medium of claim 17, wherein the method further comprises:
onboarding the first wireless device into the wireless network, comprising establishing the first control path between the first wireless device and the device via the wireless network and establishing a first physical link between the first wireless device and the device, wherein the first physical link is separate from the wireless network;
associating the first wireless device with the second device, comprising:
establishing a second control path between the first wireless device and the second device via the wireless network; and
establishing a second physical link between the first wireless device and the second device, wherein the second physical link is separate from the wireless network; and
disconnecting the second physical link and maintaining the second control path while the second physical link is disconnected.

19. The computer-readable storage medium of claim 17, wherein the method further comprises:
communicating first attribute information between the device and the first wireless device via the first control path; and
communicating second attribute information between the device and the first wireless device via the physical link, wherein a size of the second attribute information is greater than a size of the first attribute information.

20. The computer-readable storage medium of claim 17, wherein the method further comprises:
communicating, via a bridge circuit of the device, generic attribute profile (GATT) messages with the first wireless device; and
communicating IP-based messages with the second device, the first wireless device to communicate only via the wireless network, the IP-based messages comprising additional attribute messages.
